(19) United States
(12) Patent Application Publication
(10) Pub. No.: US 2010/0156751 A1
(43) Pub. Date: Jun. 24, 2010

(54) Adjustment device and satellite antenna with same

(75) Inventors: Lan-Chun Yang, Taipei Hsien (TW); Hung-Yuan Lin, Taipei Hsien (TW); Wei-Te Chien, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/591,463

(22) Filed: Nov. 20, 2009

(30) Foreign Application Priority Data
Dec. 19, 2008 (TW) 097222874

(51) Int. Cl. H01Q 3/02; F16M 11/02

(52) U.S. Cl. 343/882; 248/121

(57) ABSTRACT

An adjustment device for a satellite antenna is used for adjusting the angle of the satellite antenna receiver. The adjustment device has a fixture, a moveable element and a fastening hook mechanism. The moveable element is connected to the satellite antenna receiver, and the rotation shaft and the fixture engages with each other so the moveable element is able to rotate horizontally. The fastening hook mechanism is used for securing the fixture and the moveable element to limit the perpendicular movement between the fixture and the moveable element.

### BACKGROUND OF THE INVENTION

1. Field of the Invention

The present invention relates to an adjustment device, and, more particularly, to an adjustment device with a fastening hook mechanism.

2. Description of the Related Art

With technological developments, receivers for satellite antennas have become increasingly common in modern living. In the prior art technology, the receiver for a satellite antenna is installed on an adjustment device, so that the user can easily adjust the angle and direction of the receiver. However, the prior art adjustment device is easily deformed and knocked over by an external force. Therefore, if the receiver is disposed outdoors and suffers strong winds, the adjustment device may lose its correct receiving orientation or may be damaged due to the collapse.

Therefore, it is desirable to provide an adjustment device and a satellite antenna having the adjustment device to mitigate and/or obviate the aforementioned problems.

### SUMMARY OF THE INVENTION

A main objective of the invention is to provide an adjustment device with a fastening hook mechanism.

Another objective of the invention is to provide a satellite antenna with an adjustment device.

In order to achieve the above-mentioned objectives, a satellite antenna of the invention comprises a satellite antenna receiver and an adjustment device. The adjustment device comprises a fixture, a moveable element and a fastening hook mechanism. The moveable element is connected to the satellite antenna receiver, and the rotation shaft and the fixture are engaged with each other so that the moveable element is able to rotate horizontally. The fastening hook mechanism is used for securing the fixture and the moveable element to limit the perpendicular movement between the fixture and the moveable element.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of an adjustment device according to the invention.

FIG. 2 is a schematic drawing of the first embodiment of the adjustment device according to the invention.

FIG. 3 is a schematic drawing of a fastening hook mechanism according to the invention.

FIG. 4 is a side view of the fastening hook mechanism according to the invention.

FIG. 5 is a schematic drawing of a second embodiment of an adjustment device according to the invention.

### DETAILED DESCRIPTION OF THE PREFERRED EMBODIMENT

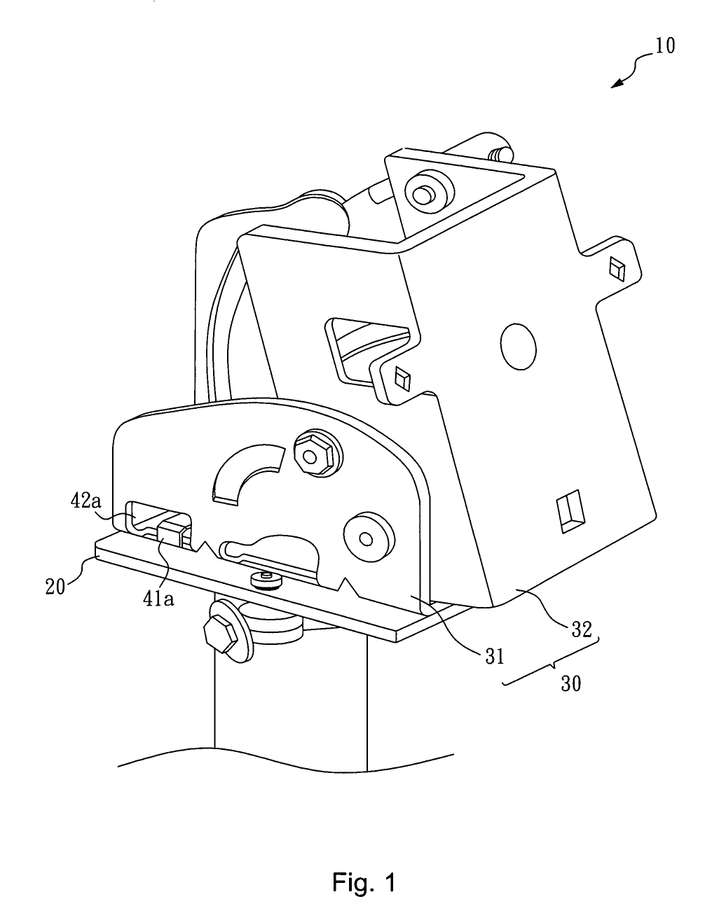

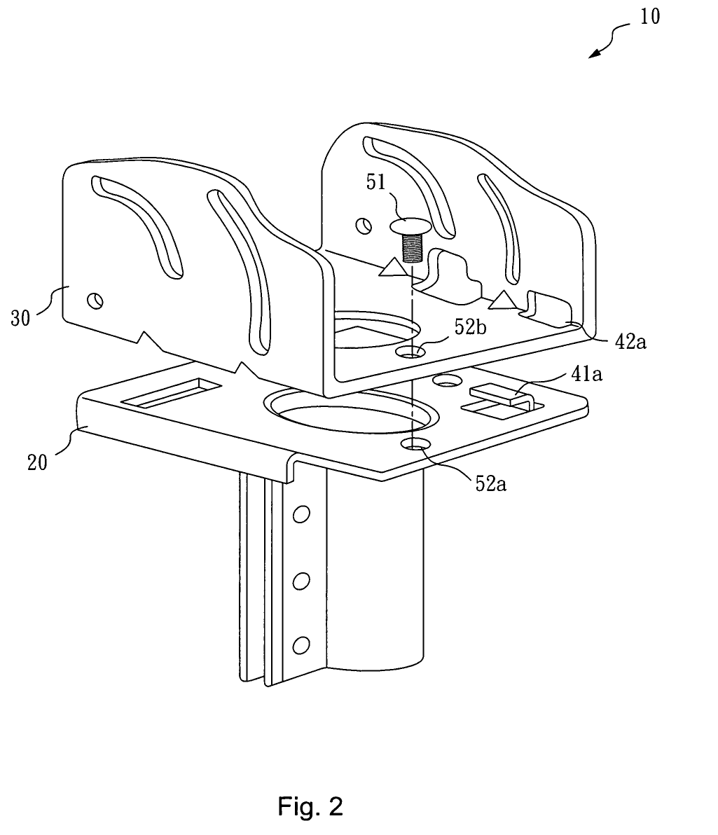

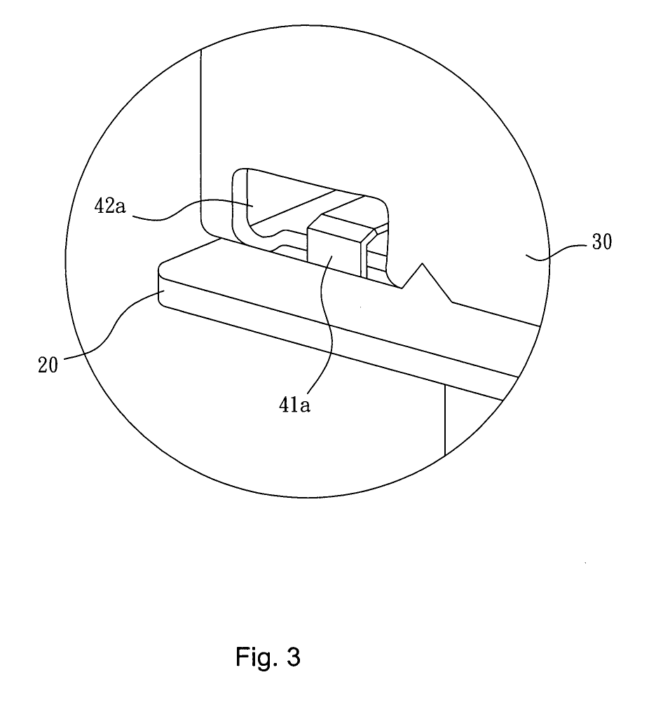

Please refer to FIG. 1 to FIG. 3. FIG. 1 is a perspective view of a first embodiment of an adjustment device according to the invention. FIG. 2 is a schematic drawing of the first embodiment of the adjustment device according to the invention. FIG. 3 is a schematic drawing of a fastening hook mechanism according to the invention.

An adjustment device 10 of the invention is utilized in a satellite antenna and combined with a satellite antenna receiver (not shown), which is able to adjust the direction and angle of the receiver. The adjustment device 10 comprises a fixture 20, a moveable element 30 and a fastening hook mechanism 41a. The fixture 20 is used for securing the adjustment device 10 at a predetermined point. The moveable element 30 is used for attachment to the satellite antenna receiver. The moveable element 30 comprises a horizontal adjustment frame 31 and a vertical adjustment frame 32. A user can use the horizontal adjustment frame 31 to adjust the direction of the satellite antenna receiver and the vertical adjustment frame 32 to adjust the vertical angle of the satellite antenna receiver. Consequently, it is very easy to adjust the direction and angle of the satellite antenna receiver.

The fixture 20 has a first rotation shaft hole 52a, and the moveable element 30 has a second rotation shaft hole 52b. A rotation shaft 51 is placed through the first rotation shaft hole 52a and the second rotation shaft hole 52b so the moveable element 30 can rotate in the horizontal plane on the fixture 20. The rotation shaft 51 can be provided screws or other equivalent elements. Since the method for adjusting the direction and the angle of the receiver is not an objective of the invention, no further explanation is provided.

In this embodiment, the structure of the fastening hook mechanism 41a is shown in FIG. 2 and FIG. 3. The fastening hook mechanism 41a extends from the fixture 20 to form an L-shaped structure. The fastening hook mechanism 41a passes through a slot 42a of the moveable element 30 and engages with the moveable element 30. Therefore, under an applied external force, the fastening hook mechanism 41a also limits movement between the fixture 20 and the moveable element 30 in the perpendicular direction.

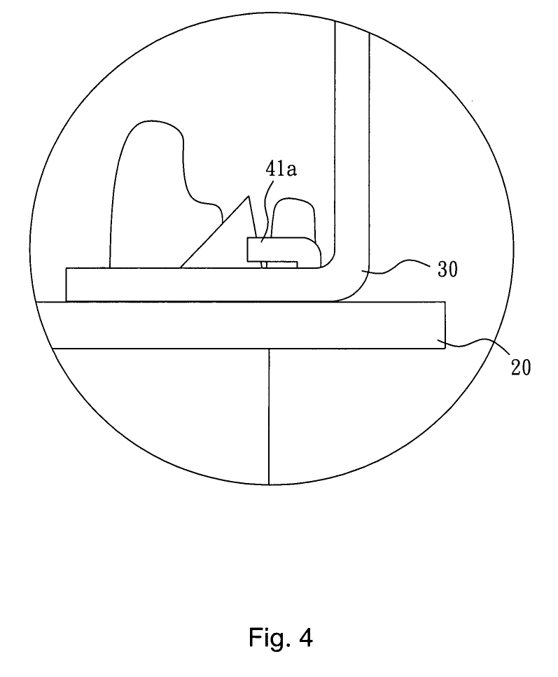

Please refer to FIG. 4. FIG. 4 is a side view of the fastening hook mechanism according to the invention.

To ensure the moveable element 30 is able to horizontally rotate on the fixture 20, a predetermined gap is placed between the fastening hook mechanism 41a and the moveable element 30 to reduce friction between the moveable element 30 and the fixture 20. The predetermined gap can be 0.5 mm or any other suitable distance.

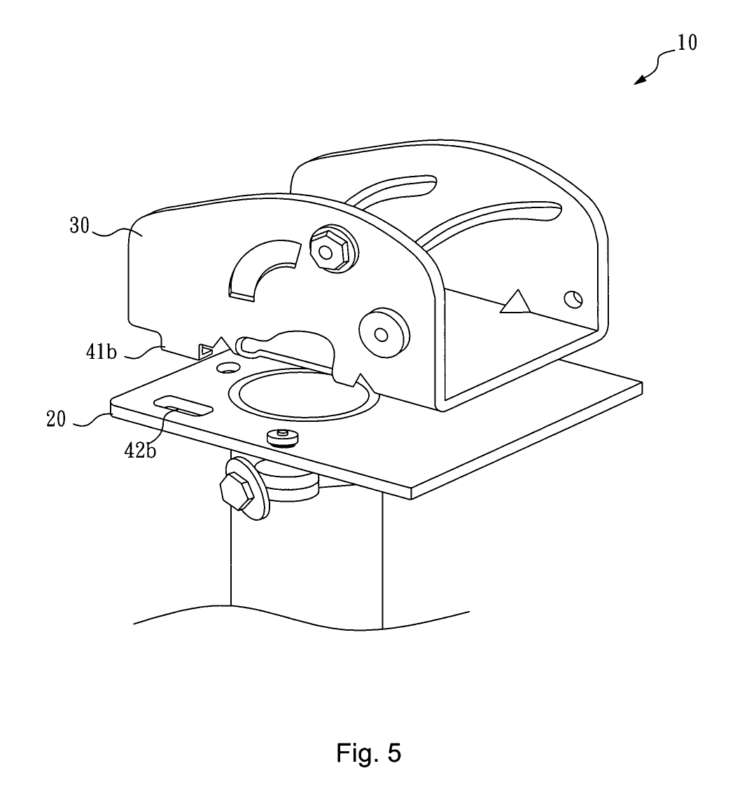

The fastening hook mechanism 41a can be disposed in positions different from that shown in the first embodiment. Please refer to FIG. 5. FIG. 5 is a schematic drawing of a second embodiment of an adjustment device according to the invention.

In the second embodiment, the fastening hook mechanism 41b extends from the moveable element 30 and also is an L-shaped structure. The fastening hook mechanism 41b passes through a slot 42b of the fixture 20 and engages with the fixture 20. A predetermined gap is also provided between the fastening hook mechanism 41b and the fixture 20. With this structure, the perpendicular movement of the fixture 20 and the moveable element 30 also is limited.

The fastening hook mechanism 41a in the first embodiment or the fastening hook mechanism 41b in the second embodiment may be modified to provide different designs. Various numbers of fastening hook mechanisms may also be provided.

Although the present invention has been explained in relation to its preferred embodiment, it is to be understood that many other possible modifications and variations can be made without departing from the spirit and scope of the invention as hereinafter claimed.

What is claimed is:

1. An adjustment device for adjusting the angle of a satellite antenna receiver, the adjustment device comprising:
a fixture;
a moveable element connected to a satellite antenna receiver and engaged with the fixture via a rotation shaft such that the moveable element is able to rotate horizontally; and
a fastening hook mechanism for securing together the fixture and the moveable element and limiting vertical movement between the fixture and the moveable element.

2. The adjustment device as claimed in claim 1, wherein the moveable element has a slot, and the fastening hook mechanism extends from the fixture to the slot to engage with the moveable element.

3. The adjustment device as claimed in claim 2, wherein a predetermined gap is disposed between the fastening hook mechanism and the moveable element.

4. The adjustment device as claimed in claim 1, wherein the fixture has a slot, and the fastening hook mechanism extends from the moveable element to the slot to engage with the fixture.

5. The adjustment device as claimed in claim 4, wherein a predetermined gap is disposed between the fastening hook mechanism and the fixture.

6. A satellite antenna with an adjustment device comprising:
a satellite antenna receiver for receiving satellite signals; and
the adjustment device for adjusting the angle of the satellite antenna receiver, the adjustment device comprising:
a fixture;
a moveable element connected to the satellite antenna receiver and engaged with the fixture via a rotation shaft such that the moveable element is able to rotate horizontally; and
a fastening hook mechanism for securing together the fixture and the moveable element and limiting vertical movement between the fixture and the moveable element.

7. The satellite antenna with an adjustment device as claimed in claim 6, wherein the moveable element has a slot, and the fastening hook mechanism extends from the fixture to the slot to engage with the moveable element.

8. The satellite antenna with an adjustment device as claimed in claim 7, wherein a predetermined gap is disposed between the fastening hook mechanism and the moveable element.

9. The satellite antenna with an adjustment device as claimed in claim 6, wherein the fixture has a slot and the fastening hook mechanism extends from the moveable element to the slot to engage with the fixture.

10. The satellite antenna with an adjustment device as claimed in claim 9, wherein a predetermined gap is disposed between the fastening hook mechanism and the fixture.
